(19) United States
(12) Patent Application Publication
(10) Pub. No.: US 2005/0276601 A1
(43) Pub. Date: Dec. 15, 2005

(54) Nonlinear data processing dedicated to an optical spectrum analyzer

(76) Inventors: Roman Z. Morawski, Quebec (CA); Andrzej Barwicz, Quebec (CA); Mohamed BEN Slima, Quebec (CA)

Correspondence Address: MCCARTHY TETRAULT LLP, BOX 48, SUITE 4700,, 66WELLINGTON STREET WEST, TORONTO, ON, M5K 1E6, CA

(21) Appl. No.: 11/069,052

(22) Filed: Mar. 2, 2005

Related U.S. Application Data
(60) Provisional application No. 60/548,958, filed on Mar. 2, 2004.

(51) Int. Cl. G01J 3/28

(52) U.S. Cl. 398/42

(57) ABSTRACT

A method and apparatus for reconstructing a spectrum from data obtained from a spectrometric transducer is described. The method comprises computng a first estimate of the spectrum by applying a first deconvolution algorithm in a first domain to the spectrum data, computing a second estimate of the spectrum by applying a second deconvolution algorithm in the first domain to the first estimate, transforming the second estimate from the first domain to a second domain, and computing a third estimate of the spectrum by applying a third deconvolution algorithm in the second domain. The first algorithm uses calibration data obtained from the spectrometric transducer and a reference transducer.

This application claims the benefit of U.S. Provisional Application No. 60/548,958, filed Mar. 2, 2004.

### BACKGROUND OF THE INVENTION

The recent expansion of telecommunications and computer communications, especially in the area of the Internet, has created a dramatic increase in the volume of worldwide data traffic that has placed an increasing demand for communication networks providing increased bandwidth. To meet this demand, fiber-optic networks and dense wavelength-division multiplexing (DWDM) communication systems have been developed to provide high-capacity transmission of multi-carrier signals over a single optical fiber. In accordance with the DWDM technology, a plurality of superimposed concurrent optical signals is transmitted on a single fiber, each signal having a different central wavelength. In DWDM optical networks, optical transmitters and optical receivers are tuned to transmit and receive on a specific wavelength.

With the widespread deployment of DWDM optical networks, knowing precisely what is happening at the optical layer of the network is quickly becoming an issue for network management and maintenance. The stability and protection of a DWDM link cannot be realized without means for analyzing its components, i.e. optical signals differing in central wavelength and called channels. For example, as the number of channels deployed in a DWDM optical network increases, say from 40 to 80 or 160, wavelength drifts and power variations are more likely to cause data errors or transmission failures. It is, therefore, becoming important for network management and maintenance to analyze the communication channels in order to obtain information relating to fault detection and identification, as well as for undertaking maintenance actions. Basic parameters of channels may be monitored in real time by “optical performance monitors”, but deeper and more precise insight into the variability of the signals may be achieved by measuring their spectra using an optical spectrum analyzer (OSA).

Another important application of OSAs is optical characterization of components, modules and systems, both for optical telecommunications and other fields of optical engineering and technology.

Optical spectrum analyzers are instruments that measure the optical power as a function of wavelength or frequency. Some advantages of optical spectrum analyzers are their dynamic range and capability to measure many discrete spectral lines. While wavelength meters may have better wavelength calibration accuracy, they typically tend to have worse dynamic ranges than a grating-based OSA. An OSA consists of a spectrometric transducer and a computing component. The spectrometric transducer converts an optical signal into a digital signal representative of the spectrum of the input optical signal. The computing component processes that digital signal in such a way as to provide the final result of measurement, i.e. an estimate of the parameters of the optical signal being monitored in a DWDM system. The spectrometric transducer performs a spectral decomposition of the optical signal; the results of that decomposition are detected by a detector; the detector converts optical signals into electrical signals; the electrical signals are transmitted to the electronics circuitry for processing and digital output.

The principle of operation of a spectrometric transducer may refer to various physical phenomena that make possible separation of spectral components of the input optical signal as discussed in detail in Chapter 3 of the book Fiber Optic Test and Measurement by D. Derickson (Prentice Hall 1998), which is hereby incorporated by reference.

Although conventional OSAs perform acceptably for some applications, they are generally bulky and costly. Thus, it would be desirable to provide for a lower-cost OSA capable of determining the spectral characteristics of the optical signals with a precision of expensive instruments available today on the market.

### SUMMARY OF THE INVENTION

In an aspect of the present invention there is provided a method of reconstructing a spectrum from data obtained from a spectrometric transducer. The method comprises the step of computng a first estimate of the spectrum by applying a first deconvolution algorithm in a first domain to the spectrum data. The first algorithm using calibration data obtained from the spectrometric transducer and a reference transducer. The method further comprise the step of computing a second estimate of the spectrum by applying a second deconvolution algorithm in the first domain to the first estimate, transforming the second estimate from the first domain to a second domain, and the step of computing a third estimate of the spectrum by applying a third deconvolution algorithm in the second domain. The first domain may be a dB domain.

### BRIEF DESCRIPTION OF THE DRAWINGS

An embodiment of the present invention will now be described by way of example only with reference to the accompanying drawings, in which:

FIG. 1 is a schematic diagram of an optical spectrum measurement instrument.

FIG. 2 is a flow diagram of a procedure for improving the quality of a spectrum estimation obtained by a spectrometric transducer.

FIG. 3a is a graph of an example of calibration data in the original domain.

FIG. 3b is a graph of an example of calibration data in the Ψ-transform domain.

FIG. 4 is a graph of an example of a spectrum estimation in the Ψ-transform domain.

FIG. 5 is a graph of an example of a further spectrum estimation in the Ψ-transform domain.

FIG. 6 is a graph of an example of a final spectrum estimation in the Ψ-transform domain.

### DETAILED DESCRIPTION OF THE INVENTION

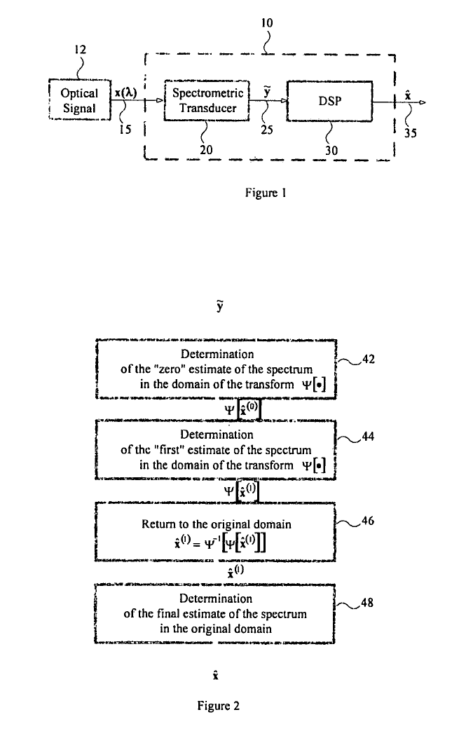

Although spectrometric transducers are used in a variety of devices, for the purpose of the following discussion it will be described in the context of an optical spectrum analyser (OSA). As illustrated in FIG. 1, an OSA 10 basically consists of a spectrometric transducer 20 and a digital signal processor (DSP) 30. The spectrometric transducer 20 converts an optical signal 12 into a digital signal \tilde{y} 25 representative of the spectrum x(λ) 15 of that optical signal. The spectrometric transducer 20 has an analog optical input and N digital electrical outputs. In practice, the spectrometric transducer 20 could be a dedicated optoelectronic transducer or a complete instrument—a spectrum analyzer with fixed measurement parameters such as wavelength range, optical resolution, sensitivity, etc.

Notations

The output of the spectrometric transducer 20 discretizes of the wavelength axis and is defined by the sequence {λₙ} such that:
λₘᵢₙ=λ₁<λ₂< . . . <λ_{N-1}<λ_{N}=λₘₐₓ Equation 1
where N is the number outputs of the spectrometric transducer 20. Thus, the average interval between the consecutive wavelength values is:

$$Δ λ = \frac{{λ}_{max} - {λ}_{min}}{N - 1}$$

The spectrum estimation-related discretization of the wavelength axis is defined by the formula:
λ′ₘ=λ′ₘᵢₙ+(m−1)Δλ′ for m=1, . . . , M Equation 2
where M is the number of discretization points, and:

$$Δ {λ}^{′} = \frac{{λ}_{max}^{′} - {λ}_{min}^{′}}{M - 1}$$

with λ′ₘᵢₙ≅λₘᵢₙ and λ′ₘₐₓ≅λₘₐₓ.

It should be noted that x(λ) 15 may denote power spectral density of the signal, PSD(λ), or a function related to that density, for example:

$$\begin{matrix}x ( λ ) = \sqrt{PSD ( λ )} & Equation 3 \\ x ( λ ) = {\int }_{λ - Δ λ / 2}^{λ + Δ λ / 2} PSD ( {λ}^{′} ) ⅆ {λ}^{′} & Equation 4 \\ x ( λ ) = {\int }_{λ - RBW / 2}^{λ + RBW / 2} PSD ( {λ}^{′} ) ⅆ {λ}^{′} & Equation 5\end{matrix}$$

where RBW is the resolution bandwidth of the spectrometric transducer 20.
Mathematical Model of the Data

The data \tilde{y}=[\tilde{y}₁ . . . \tilde{y}_{N}]^{T} 25, acquired at the outputs of spectrometric transducer 20, may be modeled by the generic form:

$$\begin{matrix}{\hat{y}}_{n} = {\int }_{- ∞}^{+ ∞} {g}_{n} ( {λ}_{n} - λ ) x ( λ ) ⅆ λ & for n = 1 , … , N\end{matrix} \qquad Equation 6$$

where each function gₙ(λ) is normalized in such a way that:

$$\begin{matrix}{\int }_{- ∞}^{0} {g}_{n} ( λ ) ⅆ λ = {\int }_{0}^{+ ∞} {g}_{n} ( λ ) ⅆ λ = 0.5 & for n = 1 , … , N\end{matrix} \qquad Equation 7$$

The above model of the data after discretization, based on the rectangle scheme of numerical integration, takes on the form:
ŷₙ≅gₙ^{T}·x for n=1, . . . , N Equation 8
where:
gₙ^{T}=[Δλ′gₙ(λₙ−λ′₁) . . . Δλ′gₙ(λₙ−λ′_{M})] for n=1, . . . , N
x=[x(λ′₁) . . . x(λ′_{M})]^{T}

This model may be given a more compact form:
ŷ≅G·x Equation 9
where G is the matrix whose rows are gₙ^{T} for n=1, . . . , N.
An alternative model of the data is:

$$\begin{matrix}Ψ [ {{y}^{\hat{\hat{}}}}_{n} ] = {\int }_{- ∞}^{+ ∞} {γ}_{n} ( {λ}_{n} - λ ) Ψ [ x ( λ ) ] ⅆ λ & Equation 10 a \\ for n = 1 , … , N & \\ or & \\ Ψ ⌊ {y}^{\hat{\hat{}}} ⌋ = Γ \cdot Ψ [ x ] & Equation 10 b\end{matrix}$$

where Ψ(●) is a real-valued transformation of the data, for example the logarithmic transformation leading to the dB scale of data representation, and Γ is a matrix whose rows are:
γₙ^{T}=[Δλ′γₙ(λₙ−λ′₁) . . . Δλ′γₙ(λₙ−λ′_{M})] Equation 11

It is evident that in general:

$${{y}^{\hat{\hat{}}}}_{n} \neq {\hat{y}}_{n}$$

and Ψ[gₙ(λ)]≠γₙ(λ), as well as

$${y}^{\hat{\hat{}}} \neq \hat{y}$$

and Γ≠Ψ[G]. Thus the use of the model for spectrum reconstruction defined by Equation 10a will provide results differing form those obtained on the basis of the model defined by Equation 6 or Equation 9. It should be noted that—when applied to a matrix—the transform Ψ(●) is effective with respect to each element of that matrix.
Procedure

The problem of spectrum estimation is non-stationary but linear, and therefore it may be solved by means of different reconstruction methods, e.g. variational methods, iterative methods, etc. Since the results of spectrum estimation are assessed in the dB domain, better results may be obtained using a nonlinear transform Ψ[●], especially for lower power components of the spectrum, in addition to the linear data model defined by Equation 9. In fact, the alternative model of the data, defined by Equation 10b, based on the use of a nonlinear transform Ψ[●], may be used for providing a good initial estimate of the solution in a numerically efficient way. This estimate should next be corrected for the effects of non-stationarity and non-adequacy of the alternative model.

The use of nonlinear transforms of data \tilde{y}=[\tilde{y}₁ . . . \tilde{y}_{N}]^{T} 25 provided by the spectrometric transducer 20 is proposed for improving the quality of estimation of the spectrum x(λ) 15 under an assumption that the wavelength-varying impulse response of the spectrometric transducer 20 is identified during its calibration. Numerical data processing dedicated to the OSA 10 comprises reference data processing aimed at the calibration of the spectrometric transducer 20, and estimation of the spectrum of the analyzed signal or of its parameters. Calibration-related data processing may be performed by an external computer, while estimation of parameters must rely on the DSP 30.

Two kinds of data and their images obtained by means of the transform Ψ[●] are necessary for the calibration of the spectrometric transducer 20: the responses of the spectrometric transducer 20 to selected test signals and responses to those signals of a reference OSA. Thus, the sets of data for calibration have the form:
D^{cal}={\tilde{y}^{cal}, x^{cal}} Equation 12
D_{Ψ}^{cal}={Ψ[\tilde{y}^{cal}], Ψ[x^{cal}]} Equation 13
where the vector of data \tilde{y}^{cal}=[\tilde{y}₁^{cal} . . . \tilde{y}_{N}^{cal}]^{T} is provided by the spectrometric transducer 20, and the vector x^{cal}=[x₁^{cal} . . . x_{N}^{cal}]^{T} by the reference OSA. The dynamic calibration of the spectrometric transducer 20 requires at least one set of data D^{cal} representative of the spectrum of a quasi-monochromatic signal.

The proposed procedure for the improvement of the spectrum estimation is depicted by the flow chart shown in FIG. 2. The sequence of steps composing the procedure is indicated by the sequence of blocks 42 to 48. In block 42 the procedure starts by providing a rough estimate of ion by means of a deconvolution algorithm DECONV0{●; ●}:
Ψ[\hat{x}⁽⁰⁾]=DECONV0{Ψ[\tilde{y}^{cal}]; \overline{γ}} Equation 14
where:

$$\overline{γ} = \frac{1}{N} {\sum }_{n = 1}^{N} {γ}_{n}$$

The vectors γₙ should be determined by means of an algorithm being a numerical implementation of the following deconvolution formula:
γₙ=DECONVγ{Ψ[\tilde{y}ₙ^{cal}]; Ψ[xₙ^{cal}]} for n=1, . . . , N Equation 15
where

$${\tilde{y}}_{n}^{cal} = {[ {\tilde{y}}_{n , 1}^{cal} … {\tilde{y}}_{n , M}^{cal} ]}^{T}$$

is the response of the spectrometric transducer 20 to the sweeping laser observed at its nth output, and

$${x}_{n}^{cal} = {[ {x}_{n , 1 }^{cal} … {x}_{n , M}^{cal} ]}^{T}$$

is the corresponding response of the reference OSA.

Then, at block 44, a “first” estimate of the solution Ψ[\hat{x}⁽¹⁾] is obtained by means of an iterative deconvolution algorithm DECONV1{●; ●}:
Ψ[\hat{x}⁽¹⁾]=DECONV1{Ψ[\tilde{y}]; \overline{γ}} Equation 16
starting from the “zero” estimate Ψ[\hat{x}⁽⁰⁾].

At block 46, Ψ[\hat{x}⁽¹⁾] is transformed back into the original domain by means of the inverse transform Ψ⁻¹[●]:
\hat{x}⁽¹⁾=Ψ⁻¹[Ψ[\hat{x}⁽¹⁾]]. Equation 17

Finally, at block 48, a correction term is computed using the results obtained at block 46, by means of an algorithm of constrained curve fitting:
\hat{x}=argₓ inf{∥\tilde{y}−G·\hat{x}⁽¹⁾∥|x∈X} Equation 18
where X is a set of constraints imposed on \hat{x}. The matrix G is composed of the vectors gₙ^{T}, which are determined using the calibration data

$${\tilde{y}}_{n}^{cal} = {[ {\tilde{y}}_{n , 1 }^{cal} … {\tilde{y}}_{n , M}^{cal} ]}^{T} and {x}_{n}^{cal} = {[ {x}_{n , 1 }^{cal} … {x}_{n , M}^{cal} ]}^{T} .$$

An algorithm that may be used for this purpose is a numerical implementation of the following deconvolution formula:
gₙ=DECONVg[\tilde{y}ₙ^{cal}; xₙ^{cal}] Equation 19
and in particular, one of the algorithms already used for implementing Equation 15.

Numerous deconvolution and generalized deconvolution algorithms may be directly used for the implementation of the operators DECONV0, DECONV1, DECONVγ, and DECONVg, as well as for the numerical implementation of Equation 18, e.g. those described in the book Deconvolution of Images and Spectra (edited by P. A. Jansson, and published by Academic Press in 1997) or in the following publications, all of which are hereby incorporated by reference:
M. Ben Slima, R. Z. Morawski., A. Barwicz: “A Recursive Spline-based Algorithm for Spectrophotometric Data Correction”, Rec. IEEE Instrum. & Meas. Technol. Conf—IMTC'93 (Irvine, USA, May 18-20, 1993), pp. 500÷503.
D. Massicotte, R. Z. Morawski., A. Barwicz: “Efficiency of Constraining the Set of Feasible Solutions in Kalman-filter-based Algorithms of Spectrophotometric Data Correction”, Rec. IEEE Instrum. & Meas. Technol. Conf.—IMTC'93 (Irvine, USA, May 18-20, 1993), pp. 496-499.
P. Brouard, R. Z. Morawski., A. Barwicz: “Approximation of Spectrogrammes by Cubic Splines Using the Kalman Filter”, Proc. 1993 Canadian Conference on Electrical & Computer Engineering (Vancouver, Canada, Sep. 14-17, 1993), pp. 900-903.
P. Brouard, R. Z. Morawski, A. Barwicz: “DSP-based Correction of Spectrograms Using Cubic Splines and Kalman Filtering”, Record of IEEE Instrum. & Meas. Technol. Conf.—IMTC'94 (Hamamatsu, Japan, May 10-12, 1994), pp. 1443÷1446.
D. Massicotte, R. Z. Morawski, A. Barwicz.: “Incorporation of a Positivity Constraint into a Kalman-filter-based Algorithm for Correction of Spectrometric Data”, IEEE Trans. Instrum. & Meas., February 1995, Vol. 44, No. 1, pp. 2-7.
M Ben Slima, R. Z. Morawski, A. Barwicz: “Kalman-filter-based Algorithms of Spectrophotometric Data Correction—Part II: Use of Splines for Approximation of Spectra”, IEEE Trans. Instrum. & Meas., June 1997, Vol. 46, No. 3, pp. 685-689.
L. Szczeciński, R. Z. Morawski, A. Barwicz: “Spectrometric Data Correction Using Recursive Quadratic Operator of Measurand Reconstruction”, Proc. Int. Conf. on Signal Processing Applications & Technology—ICSPAT'95 (Boston, USA, Oct. 24-26, 1995), pp.588-592.
L. Szczeciński, R. Z. Morawski, A. Barwicz: “Quadratic FIR Filter for Numerical Correction of Spectrometric Data”, Proc. IEEE Instrum. & Meas. Technol. Conf.—IMTC'96 (Brussels, Belgium, Jun. 4-6, 1996), pp. 1046-1049.
L. Szczeciński, R. Z. Morawski, A. Barwicz: “A Cubic FIR-type Filter for Numerical Correction of Spectrometric Data”. IEEE Trans. Instrum. & Meas., August 1997, Vol. 46, No. 4, pp. 922-928.
L. Szczeciński, R. Z. Morawski, A. Barwicz: “Numerical Correction of Spectrometric Data Using a Bilinear Operator of Measurand Reconstruction”. Instrum. Sci. & Technol., 1997, Vol. 25, No. 3, pp.197-205.
L. Szczeciński, R. Z. Morawski, A. Barwicz: “Numerical Correction of Spectrometric Data Using a Rational Filter”, J. Chemometrics, Vol. 12, issue 6, 1998, pp. 379-395.
M. Wiśniewski, R. Z. Morawski, A. Barwicz: “Using Rational Filters for Digital Correction of a Spectrometric Microtransducer”, IEEE Trans. Instrum. & Meas., Vol. 49, No. 1, February 2000, pp. 43-48.
M. P. Wiśniewski, R. Z. Morawski, A. Barwicz: “An Adaptive Rational Filter for Interpretation of Spectrometric Data”, IEEE Trans. Instrum. & Meas., 2003 (in press).
P. Sprzeczak, R. Z. Morawski: “Calibration of a Spectrometer Using a Genetic Algorithm”, IEEE Trans. Instrum. & Meas., Vol. 49, No. 2, April 2000, pp. 449-454.
P. Sprzeczak, R. Z. Morawski: “Cauchy-filter-based Algorithms for Reconstruction of Absorption Spectra”, IEEE Trans. Instrum. & Meas., Vol. 50, No. 5, October 2001, pp. 1123-1126.
P. Sprzeczak, R. Z. Morawski: “Cauchy Filters versus Neural Networks when Applied for Reconstruction of Absorption Spectra”, IEEE Trans. Instrum. & Meas., Vol. 51, No. 4, August 2002, pp. 815-818.

In particular, the following version of the Jansson deconvolution algorithm may be appropriate for solving the problem of correction defined by Equation 17:
\hat{x}⁽²⁾=\hat{x}⁽¹⁾ Equation 20a
\hat{x}⁽ⁱ⁺¹⁾=\hat{x}⁽ⁱ⁾+α·diag{β⁽ⁱ⁾}·G^{T}·(\tilde{y}−G·\hat{x}⁽ⁱ⁾) for i=2,3 , . . . Equation 20b
where:

$${β}_{m}^{( i )} = 1 - \vert \frac{2 {\tilde{x}}_{m}^{( i )}}{{\tilde{x}}_{max} - {\tilde{x}}_{min}} - 1 \vert for m = 1 , … , M$$

The parameter of convergence α should be chosen experimentally, while the constraints \hat{x}ₘᵢₙ and \hat{x}ₘₐₓ may be deduced from the spectrometric transducer 20 data \tilde{y} 15 and the relationship between the actual and target resolution bandwidths of the spectrometric transducer 20, RBWY and RBWX, respectively:

$$\begin{matrix}{\hat{x}}_{min} = \{ \begin{matrix}\frac{RBWY}{RBWX} inf \{ \tilde{y} \} & if inf \{ \tilde{y} \} < 0 \\ 0 & otherwise\end{matrix} & Equation 21 a \\ {\hat{x}}_{max} = \{ \begin{matrix}\frac{RBWY}{RBWX} sup \{ \tilde{y} \} & if sup \{ \tilde{y} \} > 0 \\ 0 & otherwise\end{matrix} & Equation 21 b\end{matrix}$$

### EXAMPLE

The general procedure, described in the previous section, will be illustrated with an example based on the following transform:
Ψ[●]=10·log₁₀(●) Equation 22

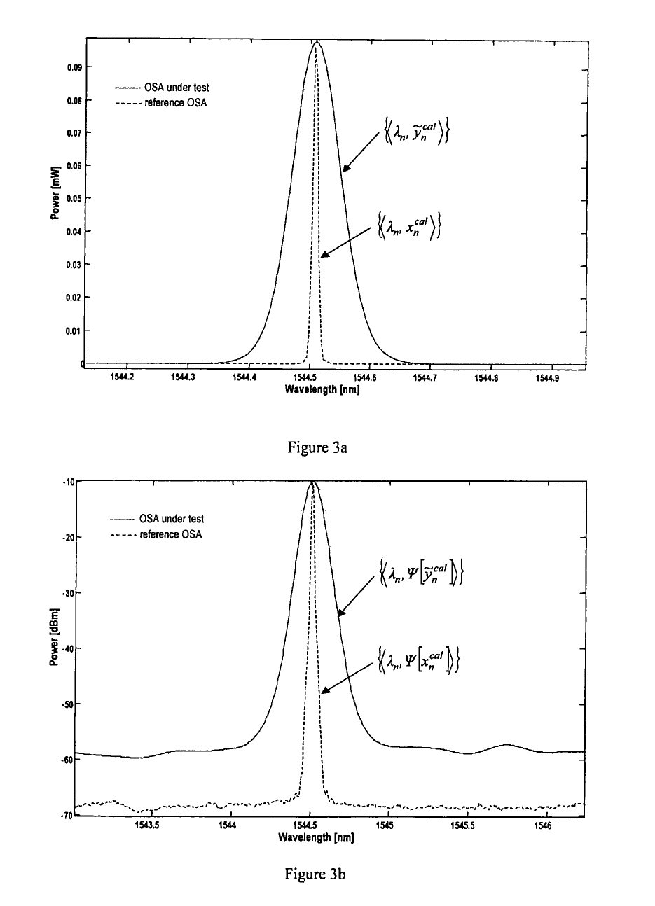

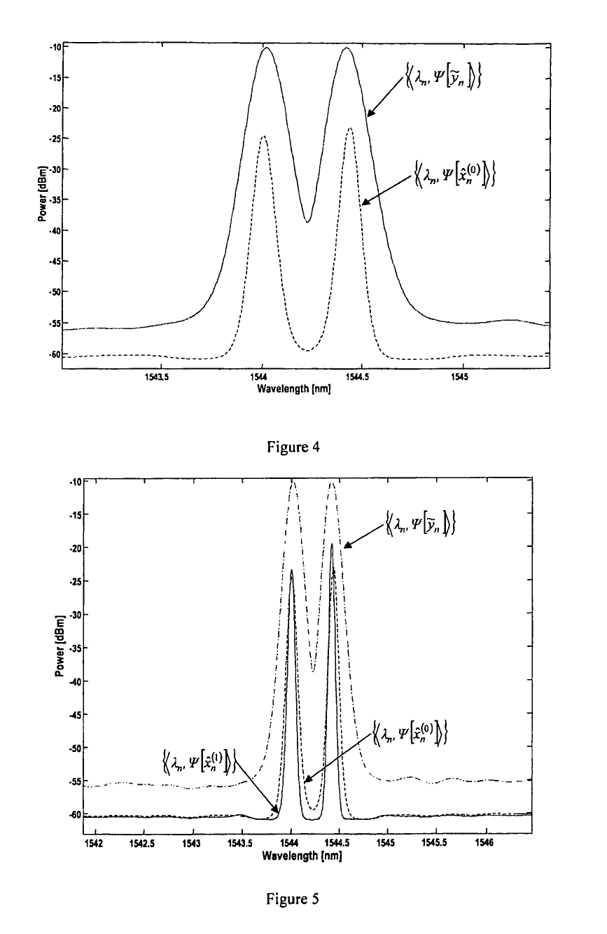

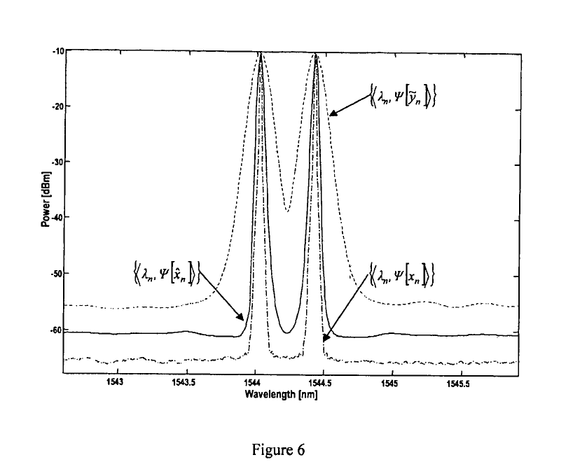

The data used for the spectrometric transducer 20 calibration are shown in FIG. 3. Following the procedure depicted by the flow chart shown in FIG. 2, at box 42, Equation 14 is implemented using the Gold algorithm with the data from FIG. 3 to obtain the “zero” estimate of the spectrum in the Ψ-transform domain, Ψ[\hat{x}⁽⁰⁾], which is shown in FIG. 4. Then, at box 44, Equation 16 is implemented using the Gold algorithm, starting from the “zero” estimate depicted in FIG. 4, to obtain Ψ[\hat{x}⁽¹⁾], which is shown in FIG. 5. At box 46 Ψ[\hat{x}⁽¹⁾] is returned to the original domain so that, at box 48, Equation 20 may implemented using the Jansson algorithm, starting from the “first” estimate depicted in FIG. 5 to obtain the final estimate of the spectrum. The final estimate of the spectrum is shown, in the transform domain, in FIG. 6. All the data in FIGS. 3 to 6 are normalized according to Equation 5.

It will be appreciated that implementation of the respective algorithms are performed within a digital signal processor, (DSP) forming part of the transducer 20. The algorithms may also be implemented in a generalised software as an instruction set to be processed within a general purpose computer or may be implemented as a set of instructions embodied in a micro-processor.

Although the present invention has been described by way of a particular embodiment and example thereof, it should be noted that it will be apparent to persons skilled in the art that modifications may be applied to the present particular embodiment without departing from the scope of the present invention.

1. A method for reconstructing a spectrum from data obtained from a spectrometric transducer, comprising:
computng a first estimate of the spectrum by applying a first deconvolution algorithm in a first domain to said spectrum data, said first algorithm using calibration data obtained from said spectrometric transducer and a reference transducer;
computing a second estimate of the spectrum by applying a second deconvolution algorithm in the first domain to the first estimate;
transforming the second estimate from the first domain to a second domain; and
computing a third estimate of the spectrum by applying a third deconvolution algorithm in the second domain.

2. The method of claim 1, wherein the first domain is a dB domain.
